(19) United States
(12) Patent Application Publication
(10) Pub. No.: US 2026/0179994 A1
(43) Pub. Date: Jun. 25, 2026

(54) FUEL CELL

(71) Applicant: SYMBIO FRANCE, Saint-Fons (FR)

(72) Inventors: Guillaume Eric Claude Bonhomme, Charvieu Chavagneux (FR); Alexandre Begel, Venissieux (FR)

(21) Appl. No.: 19/129,048

(22) PCT Filed: Nov. 23, 2023
(86) PCT No.: PCT/EP2023/082804

§ 371 Date: May 12, 2025

(30) Foreign Application Priority Data
Nov. 24, 2022 (FR) 2212259

(51) Int. Cl. H01M 8/248; H01M 8/10; H01M 8/241

(52) U.S. Cl. CPC H01M 8/248; H01M 8/241; H01M 2008/1095

(57) ABSTRACT

Fuel cell, comprising: a base plate (11); a stack (20) held against the base plate (11); and a compression system, which comprises: a support plate (30), movable and held against the stack (20); springs (50), held against the support plate (30); and a clamp (40), held against the springs (50). For the fuel cell to be particularly stable over time, the fuel cell comprises a first sliding connection (70), to guide the support plate (30) in sliding relative to the base plate (11) and draw plates (60), separated from each other and having anchors attaching them to the base plate (11) and to the clamp (40) to maintain the stack (20) in compression between the base plate (11) and the support plate (30) by means of the anchors, under the action of the springs (50).

The invention concerns a fuel cell.

US202014465A1 describes a fuel cell with a stack constituted of electrochemical cells. The electrochemical cells are stacked and maintained in compression along a stacking direction, between two terminal plates. To maintain the stack in compression, the terminal plates are bordered by a retaining system, comprising transverse members, disc springs, and rods. The transverse members are arranged on either side of the terminal plates, being connected to each other by the rods, which extend from one end of the stack to the other, being parallel to the stacking direction. At each end of the stack, under the action of the rods, the transverse members are held against the terminal plate, with the interposition of the disc springs and the pressure distribution plate between the transverse members and the terminal plate, on each side of the stack. A casing surrounds the assembly.

This known fuel cell presents the disadvantage that, in practice, the compression of the stack can lack precision and/or be unstable over time, notably due to axial deformations of the stack caused by thermal stresses, which can result in generating transverse stresses on the stack and the compression retaining system.

The invention aims to resolve the disadvantages of the prior art by proposing a new fuel cell that is particularly stable over time.

The invention has as its object a fuel cell comprising: a base plate; a stack, which comprises electrochemical cells stacked according to a compression direction, and which is held against the base plate according to the compression direction; and a compression system. The compression system comprises: a support plate, which is movable relative to the base plate parallel to the compression direction, and which is held against the stack according to the compression direction; springs, which are held against the support plate according to the compression direction; and a clamp, which is held against the springs according to the compression direction. According to the invention, the fuel cell comprises a first sliding connection, by means of which the support plate is guided in sliding relative to the base plate, according to the compression direction. According to the invention, the compression system further comprises draw plates, separated from each other, each draw plate comprising anchors by means of which the draw plate is attached to the base plate and to the clamp, the draw plates thus ensuring that the stack is maintained in compression between the base plate and the support plate, according to the compression direction, by means of the anchors, under the action of the springs bearing on the clamp.

One idea underlying the invention is to transversely maintain the position of the support plate using the sliding connection, to ensure that, according to the compression direction, the support plate remains perfectly aligned with the base plate and is unlikely to unbalance the distribution of the compression force applied to the stack by the clamp by means of the springs. The draw plates, with their plurality of anchors, take up most of the torsional stresses that could be applied to the stack and the compression system. The stability of the stack compression over time is therefore improved.

Preferably, the first sliding connection comprises a primary slide, attached to the support plate, and a secondary slide, attached to the base plate, the primary slide and the secondary slide being received within each other, so as to slide relative to each other according to the compression direction, thus guiding the sliding of the support plate relative to the base plate.

Preferably, the fuel cell comprises a casing, which contains the stack, the compression system and the clamp, which is fixedly attached to the base plate. Preferably, the secondary slide is fixedly attached to the base plate by being fixedly attached to the casing, preferably at the height of the clamp or the springs according to the compression direction.

Preferably, each draw plate comprises a common tie and individual ties, which carry the anchors, each individual tie being attached to the common tie and having an adjustable position relative to the common tie according to the compression direction, to adjust the position of the anchors by means of which the draw plate is attached to the clamp relative to those of the anchors by means of which the draw plate is attached to the base plate.

Preferably, so that the respective position of the individual ties relative to the common tie is adjustable, each individual tie is linked to the common tie by a helical connection parallel to the compression direction.

Preferably, each draw plate comprises stringers, parallel to the compression direction.

Preferably, each draw plate comprises a crosspiece, rigidly connecting the stringers to each other by being fixedly linked to said stringers, the crosspiece being arranged between the clamp and the base plate.

Preferably, for each draw plate, at least two stringers are distant by an inter-stringer distance that is greater than 50% of a width of the stack, the inter-stringer distance being measured perpendicular to the compression direction and the width of the stack being measured parallel to the inter-stringer distance.

Preferably, each stringer is axially aligned, according to the compression direction, with one of the anchors of the draw plate, and preferably with two of the anchors of the draw plate, being arranged between said two anchors.

Preferably, at least one of the anchors comprises at least one wing, which extends radially from said stringer, and which bears against the base plate in the opposite direction to the compression direction, to attach the draw plate to the base plate, said at least one wing being arranged in a plane of the plate along which the stringers extend.

Preferably, for each draw plate, the anchors comprise primary anchors, by means of which the draw plate is attached to the base plate, and secondary anchors, by means of which the draw plate is attached to the clamp.

Preferably, the draw plates comprise a first draw plate and a second draw plate, which are parallel to each other.

Preferably, the first draw plate and the second draw plate are arranged on either side of the stack, the opposite way relative to the stack.

Preferably, the fuel cell comprises a second sliding connection, by means of which the clamp is guided in sliding relative to the support plate, according to the compression direction.

Preferably, the clamp is made in different parts independent of each other.

The invention and other advantages thereof will appear in light of the following description of embodiments in accordance with its principle, made with reference to the appended figures wherein:

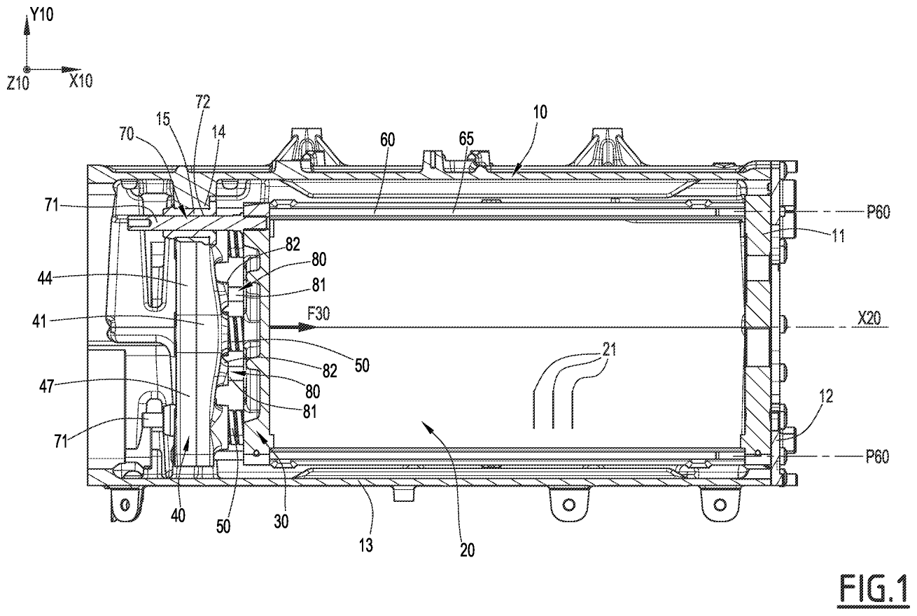

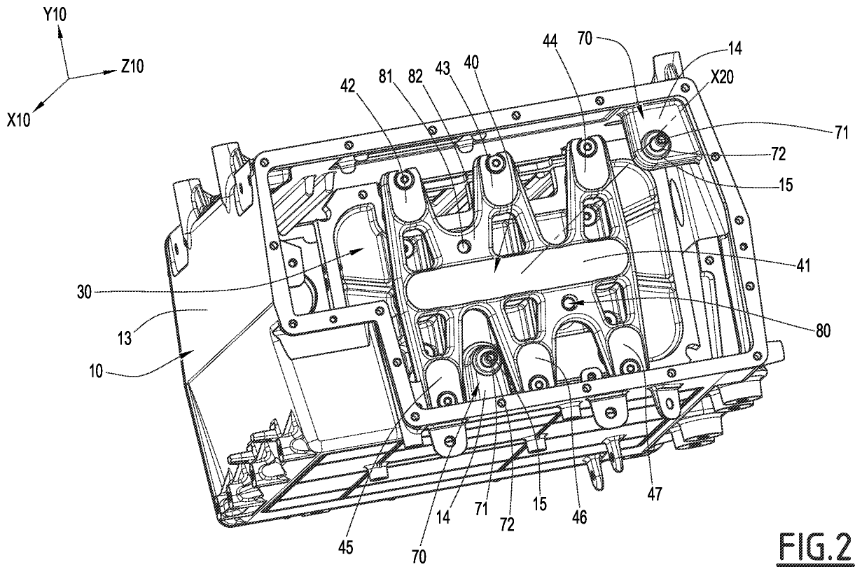

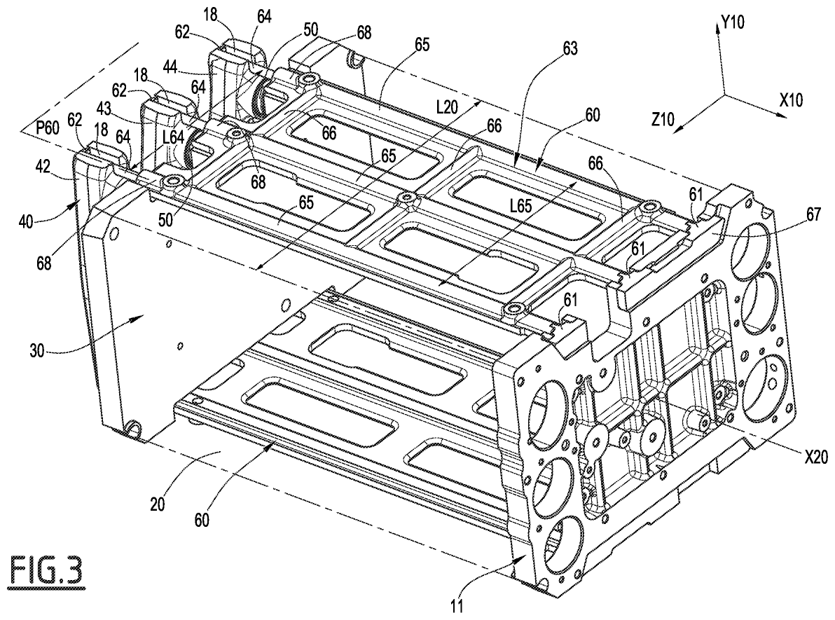

FIG. 1 shows a longitudinal section of a fuel cell according to one embodiment of the invention.
FIG. 2 is a perspective view of the fuel cell of FIG. 1.
FIG. 3 is a perspective view, from another angle, of a subassembly belonging to the fuel cell of the previous figures, including a base plate and a compression system.

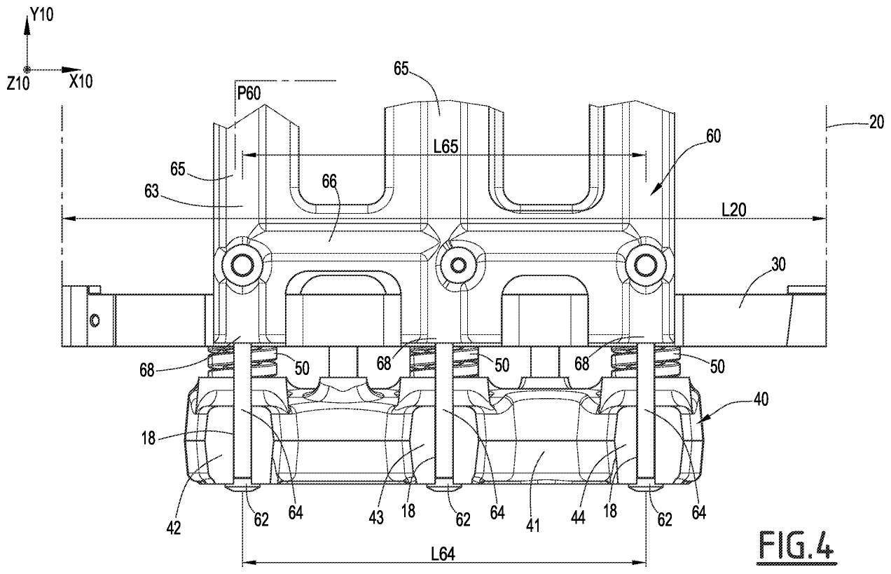

FIG. 4 is a partial side view of the subassembly of FIG. 3.

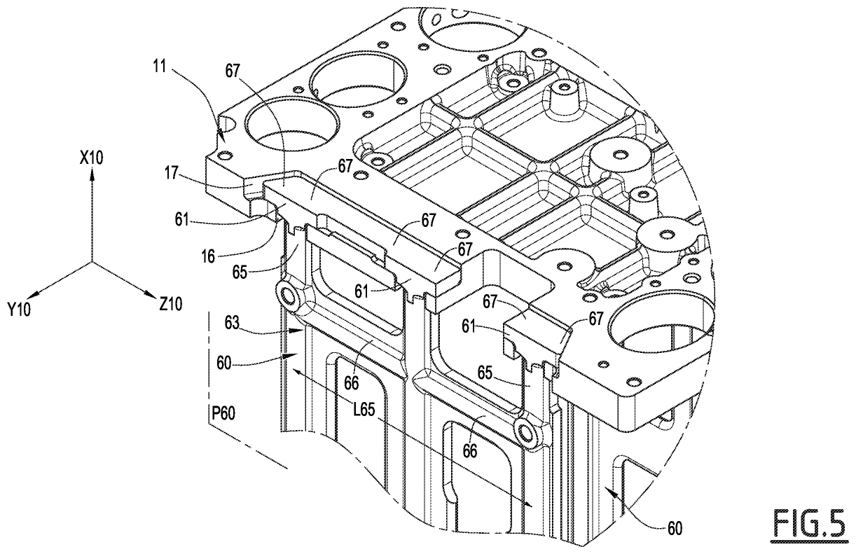

FIG. 5 is a partial perspective view of the subassembly of FIGS. 3 and 4.

FIGS. 1 and 2 show a fuel cell, which comprises a base plate 11, a stack 20, and a compression system. Preferably, the fuel cell comprises a casing 10. The compression system comprises a support plate 30, a clamp 40, springs 50, and draw plates 60, here only two draw plates 60. FIGS. 3 to 5 show the fuel cell without the casing 10 and without the stack 20.

A compression direction X10, a first transverse direction Y10, and a second transverse direction Z10 are defined. These three directions are perpendicular to each other and fixed relative to the base plate 11.

The fuel cell is preferably used in a vehicle, notably an automobile, such as a car or a truck, or another rolling vehicle, to ensure the power supply to one or more motors ensuring the propulsion of said vehicle.

The stack 20 is represented by dashed lines in FIGS. 3 and 4. The stack 20 is a stack of electrochemical cells 21, shown schematically in FIG. 1, but which are not individually represented for simplification, as the stack 20 includes, for example, between 250 and 400 cells 21. Each electrochemical cell 21 is, for example, constituted of an anode and a cathode, separated by a polymer membrane allowing the passage of protons from the anode to the cathode. During the use of the fuel cell, each anode of the stack 20 is supplied with fuel, for example, dihydrogen, and each cathode of the stack 20 is supplied with an oxidant, for example, oxygen or air.

To form the stack 20, the electrochemical cells 21 are stacked, in other words, superimposed, according to the compression direction X10. Each cell 21 extends according to an individual plane, perpendicular to the direction X10. Preferably, when the fuel cell is in operation, for example in the vehicle, the compression direction X10 is approximately horizontal.

For this stack 20, a central axis X20 is defined, which passes through the stack 20 and is parallel to the direction X10. The axis X20 also passes through the base plate 11, the support plate 30, and the clamp 40.

The casing 10 surrounds and protects the stack 20, the compression system, and the base plate 11, in other words, it contains these elements. The casing 10 comprises a transverse wall 12 and a longitudinal wall 13. The transverse wall 12 is perpendicular to the direction X10. The axis X20 passes through the wall 12. The longitudinal wall 13 is parallel to the direction X10. The longitudinal wall 13 is a peripheral wall, in other words, tubular, which surrounds the stack 20, extending to the wall 13, according to the direction X10, and beyond the clamp 40, in the opposite direction to the direction X10. The longitudinal wall 13 surrounds the axis X20. The wall 12 is fixedly attached to the wall 13, so as to close the casing 10 at one end of the wall 13. The stack 20 is arranged inside the casing 10, in particular, inside the wall 13. Overall, the walls 12 and 13 are arranged so that the casing 10 has a general parallelepiped shape.

Preferably, the transverse wall 12 receives in support, according to the compression direction X10, the base plate 11. The base plate 11 is oriented perpendicular to the direction X10 and is then held flat against the wall 12. Here, the base plate 11 is fixed to the wall 12, for example, using screws. More generally, it is advantageously provided that the base plate 11 is fixedly attached to the casing 10.

The base plate 11 here serves as a fixed terminal plate for the stack 20, in that the stack 20 is supported, flat, according to the compression direction X10, against the base plate 11. However, it could be provided that the stack 20 comprises a distinct fixed terminal plate, by means of which the stack 20 would come to bear against the base plate 11.

Preferably, the base plate 11 includes openings through which connectors can pass, not represented, provided to be connected to fluid circulation pipes, thus allowing the stack 20 to be supplied with fuel, oxidant, a possible cooling fluid, and to evacuate reaction products if any. Corresponding openings are advantageously provided on the transverse wall 12.

The stack 20 is received between the support plate 30 and the base plate 11, being compressed, according to the direction X10, between these two plates 11 and 30. In particular, the plate 30 applies a compression force F30 on the stack 20, directed according to the direction X10, the stack 20 being held against the base plate 11. The support plate 30 is held against the stack 20 according to the direction X10, opposite the base plate 11. The support plate 30 is oriented perpendicular to the direction X10 and is held flat against the stack 20.

The support plate 30 and the base plate 11 being held flat against the stack 20, they advantageously ensure that the mechanical stresses resulting from the force F30 are distributed over the end surfaces of the stack 20.

The support plate 30 is movable relative to the base plate 11 parallel to the compression direction X10, in order that the distance between the support plate 30 can evolve during the use of the fuel cell, over time, and thus adapt to dimensional variations of the stack 20, likely to be caused by various factors, notably thermal.

The fuel cell comprises a sliding connection 70 for the support plate 30, called the sliding connection plate 70, formed inside the casing 10. The support plate 30 is guided in sliding relative to the base plate 11, according to the compression direction X10, by this sliding connection plate 70. In other words, the sliding connection plate 70 prevents the support plate 30 from pivoting as a whole relative to the base plate 11 and prevents the plate 30 from displacing transversely to the direction X10, notably according to the directions Y10 and Z10, relative to the base plate 11. The sliding connection plate 70 thus stabilizes the support plate 30 and the stack 20 during the assembly of the fuel cell, but also during the use of the fuel cell. By means of these arrangements, the deformations of the stack 20, notably under the effect of the heat it is likely to generate, as well as possible vibrations, are therefore less likely to affect the integrity of the fuel cell.

In the present example, as visible in FIGS. 1 and 2, the sliding connection plate 70 comprises primary slide plates 71 and secondary slide plates 72, distributed in pairs. In the present example, two pairs of slide plates 71 and 72 are provided. At a minimum, a single pair with a primary slide plate 71 and a secondary slide plate 72 is provided. Each primary slide plate 71 is attached, preferably fixedly, to the support plate 30. Each secondary slide plate 72 is attached, preferably fixedly, to the base plate 11. For this, preferably, the secondary slide plate 72 is fixedly attached to the casing 10, itself fixedly attached to the base plate 11. For each pair, the slide plates 71 and 72 are received within each other, so as to slide relative to each other according to the direction X10, thus guiding the sliding of the support plate 30 relative to the base plate 11. Each pair of slide plates 71 and 72 is advantageously arranged, perpendicular to the direction X10, between the wall 13 of the casing and the clamp 40, and, according to the direction X10, at the height of the clamp 40. In the present example, for a given primary slide plate 71, possibly for each primary slide plate 71, the primary slide plate 71 is constituted by a rod, parallel to the direction X10 and fixedly attached to the plate 30 by being mounted on the plate 30. For example, as visible in FIG. 1, the rod of a given primary slide plate 71 comprises a threaded end, received in a tapped hole provided in the plate 30, and a smooth end, to guide the sliding. The rod, for example, protrudes from the plate 30 in the opposite direction to the direction X10 relative to the stack 20, and can extend beyond the clamp 40.

In the present example, each secondary slide plate 72 comprises a slide bore, parallel to the direction X10 and fixedly attached to the wall 13 of the casing 10, so as to be fixedly attached to the base plate 11 by means of the casing 10. Preferably, all the slide bores are formed at the same height according to the direction X10, being distributed in a plane perpendicular to the direction X10. Preferably, for a given secondary slide plate 72, possibly for each secondary slide plate 72, the slide bore is formed through a respective lug 14 belonging to the casing 10. Each lug 14 is, for example, directly, fixedly attached to the wall 13, on the inside of the casing 10, approximately at the height of the clamp 40. For a given secondary slide plate 72, possibly for each secondary slide plate 72, a sliding sleeve 15 can also be provided, forming the slide bore and being fixedly received through the corresponding lug 14. The sliding sleeve 15 advantageously allows to obtain more precise sliding of the rod than with a slide bore arranged directly through the lug 14 and/or allows to have, for the slide bore, a material less sensitive to wear and/or favoring a sliding of the rod within it according to the direction X10.

Several springs 50 are provided, here nine springs 50. Here, each spring 50 is advantageously a compression spring, oriented parallel to the direction X10. Here, each spring 50 is a helical spring, but another type of spring could be provided, for example, constituted of Belleville washers, in other words, a spring washer, generally of conical shape. Each spring 50 is held against the support plate 30 according to its own support axis, which is parallel to the direction X10. In other words, the support plate 30 is interposed between the stack 20 and the springs 50, according to the direction X10. Preferably, the springs 50, and therefore their respective support axes, are regularly distributed over the surface of the support plate 30, so that the force F30 can be distributed by the support plate 30 on the stack 20, under the collective action of the springs 50. Here, for example, three rows of three springs 50 are provided, forming a grid the lines and columns of which are parallel to the directions Y10 and Z10.

As visible in FIGS. 1 and 4, each spring 50 is interposed between the clamp 40 and the support plate 30, according to the direction X10. In other words, the clamp 40 is held against each spring 50, according to the direction X10. It is under the action of the clamp 40 that the springs 50 press on the support plate 30 so that the support plate 30 applies the compression force F30. By bearing on the clamp 40 and by being elastically deformed according to the direction X10, the springs 50 collectively apply, by elasticity, the forces on the support plate 30, directed according to the direction X10. The support plate 30 transmits these forces to the stack 20, in the form of the compression force F30.

Preferably, the pairs of slide plates 71 and 72 are distributed at the transverse ends of the plate 30. In a plane perpendicular to the direction X10, it is advantageously provided that the two pairs of slide plates 71 and 72 are arranged on either side of the springs 50, or possibly between the springs 50 of one of the columns of springs arranged on the outside. It is advantageously provided that, in the plane perpendicular to the direction X10, the pairs of slide plates 71 and 72 border the clamp 40, or possibly pass through the clamp 40 near a peripheral edge of said clamp 40. For example, the first pair of slide plates 71 and 72 are arranged in an oblique transverse direction relative to, the second pair of slide plates 71 and 72, the oblique transverse direction being oblique relative to the directions Y10 and Z10 and perpendicular to the direction X10.

Preferably, the fuel cell comprises a sliding connection 80 between the support plate 30 and the clamp 40, called the clamp sliding connection 80, formed inside the casing 10. The clamp 40 is guided in sliding relative to the support plate 30, according to the compression direction X10, by this clamp sliding connection 80. In other words, the clamp sliding connection 80 prevents the clamp 40 from pivoting as a whole relative to the plate 30 and prevents the clamp 40 from displacing transversely relative to the direction X10, notably according to the directions Y10 and Z10, relative to the plate 30. The clamp sliding connection 80 thus allows the clamp 40 and the stack 20 to be stabilized during the manufacture of the fuel cell, but also during the use of the fuel cell.

In the present example, as visible in FIGS. 1, 2, and 4, the clamp sliding connection 80 comprises primary clamp slides 81 and secondary clamp slides 82, distributed in pairs.

In the present example, two pairs of clamp slides 81 and 82 are provided. At a minimum, a single pair with a primary clamp slide 81 and a secondary clamp slide 82 is provided. Each primary clamp slide 81 is attached, preferably fixedly, to the support plate 30. Each secondary clamp slide 82 is attached, preferably fixedly, to the clamp 40. For each pair, the clamp slides 81 and 82 are received within each other, so as to slide relative to each other according to the direction X10, thus guiding the sliding of the support plate 30 relative to the clamp 40.

In the present example, for a given primary clamp slide 81, possibly for each primary clamp slide 81, the primary clamp slide 81 is constituted by a rod, parallel to the direction X10 and fixedly attached to the plate 30 by being mounted on the plate 30. Each rod, for example, protrudes from the plate 30 in the direction of the clamp 40.

In the present example, for a given secondary clamp slide 82, possibly for each secondary clamp slide 82, the secondary clamp slide 82 comprises a slide bore, parallel to the direction X10. Here the slide bore is fixedly attached to the clamp 40 by being formed by the clamp 40 itself. Each slide bore is advantageously open in the direction of the plate 30 and in alignment with the corresponding rod, according to the direction X10, so as to receive said rod in sliding.

Preferably, the pairs of clamp slides 81 and 82 are distributed over the surface of the plate 30. Here, it is provided that the two pairs of clamp slides 81 and 82 are arranged between the springs 50. In particular, as visible in FIG. 2, the pairs of clamp slides 81 and 82 are arranged on either side of a spring 50 arranged in the middle of the column of springs 50 arranged in the center, diametrically opposed relative to this central spring 50. The axis X20 advantageously passes through the central spring 50. A first pair of clamp slides 81 and 82 are arranged between the central spring 50 and another spring 50, arranged in a corner of the grid of springs 50. The second pair of clamp slides 81 and 82 are arranged between the central spring 50 and another spring 50, arranged in an opposite corner of the grid of springs 50. For example, the first pair is arranged in an oblique transverse direction relative to the central spring 50, the oblique transverse direction being oblique relative to the directions Y10 and Z10 and perpendicular to the direction X10. For example, the second pair is arranged according to the same oblique direction relative to the central spring 50, but in the opposite direction relative to the first pair.

Preferably, when two pairs of slide plates 71 and 72 and two pairs of clamp slides 81 and 82 are provided, they are arranged according to a quadrilateral, drawn in projection in a plane perpendicular to the direction X10, with a successive alternation of a pair of slide plates 71 and 72 and a pair of clamp slides 81 and 82 on its perimeter. In other words, the two pairs of slide plates 71 and 72 are at the ends of a first diagonal of the quadrilateral and the two pairs of clamp slides 81 and 82 are at the ends of a second diagonal of the quadrilateral, crossing the first near the center of the clamp 40 and/or the central spring 50. In the present example, the clamp 40 forms an openwork frame that extends, in general, according to a plane perpendicular to the direction X10. However, the clamp 40 could be presented in the form of a non-openwork plate.

As visible in FIG. 2, the clamp 40 comprises, for example, a main arm 41, parallel to the direction Z1, and secondary arms parallel to the direction Y1, here the secondary arms 42, 43, 44, 45, 46, and 47. The secondary arms 42 to 47 are rigidly linked to the main arm 41, for example, forming a monobloc piece, in one piece with the main arm 41. For example, the secondary arms 42, 43, and 44 extend from the main arm 41 according to the direction Y10, being parallel to each other and distant from each other. For example, the secondary arms 45, 46, and 47 extend from the main arm 41 in the opposite direction to the direction Y10, being parallel to each other and distant from each other. Here the secondary arms are distributed in pairs, in that, according to the direction Y10, the arm 42 is aligned with the arm 45, the arm 43 is aligned with the arm 46, and the arm 44 is aligned with the arm 47. Preferably, as many pairs of arms as there are columns of springs 50 are provided. Here, there are three columns of three springs 50, so three pairs of secondary arms are provided.

Each secondary arm 42 to 47 receives in support one of the springs 50, in the opposite direction to the direction X10. The secondary arms 42, 43, and 44 respectively receive in support the springs 50 of a first column. The secondary arms 45, 46, and 47 respectively receive in support the springs 50 of a second column. The main arm 41 receives in support, in the opposite direction to the direction X10, respectively the springs of a third column, arranged between the first column and the second column.

Preferably, each bore forming one of the clamp slides 82 is formed on a portion of the clamp 40 that connects two secondary arms and the main arm, this portion being, for example, formed in one piece with said arms. Here, one of the bores is formed on a portion of the clamp 40 that connects the arm 41, the arms 42 and 43, and the other of the bores is formed on a portion of the clamp 40 that connects the arm 41, the arms 46 and 47.

As seen previously, independently of the embodiment of the clamp 40, each elastically deformed spring 50 bears on the clamp 40, in the opposite direction to the direction X10, to be able to collectively apply forces on the support plate 30, so that the support plate 30 itself applies the force F30 to the stack 20.

The clamp 40 itself is retained relative to the base plate 11, in the opposite direction to the direction X10, by the draw plates 60, each draw plate 60 being attached, on the one hand, to the clamp 40, and on the other hand, to the base plate 11. By being thus retained by the draw plates 60, during the use of the fuel cell, the clamp 40 is held relative to the base plate 11 according to the direction X10, unlike the support plate 30 which is likely to be displaced relative to the base plate 11 according to the direction X10, under the effect of deformations of the stack 20. Nevertheless, as explained below, an adjustment of the position of the clamp 40 can be made relative to the base plate 11 according to the direction X10, by means of the draw plates 60, to adjust the compression force applied by the springs 50 on the stack 20.

Preferably, it is provided that only the draw plates 60 retain the clamp 40 in the direction opposite to the direction X10. In particular, it is advantageously not provided for other organs, such as ties or rods, to retain the clamp 40 relative to the base plate 11, parallel to the direction X10. In particular, it is not provided that the casing 10 retains the clamp 40 relative to the base plate 11, parallel to the direction X10. To apply the force F30, the support plate 30 is attached to the base plate 11, being retained relative to the base plate 11 by a chain of elements constituted by, successively, the draw plates 60, the clamp 40, and the springs 50.

In the present example, exactly two draw plates 60 are provided, as visible in FIGS. 1 and 3. More than two draw plates 60 could be provided. However, an advantage of providing the draw plates 60 rather than individual ties such as rods is to facilitate the assembly of the fuel cell by limiting the number of pieces to be assembled. In other words, it may be preferred to provide as few draw plates 60 as possible. Indeed, each draw plate 60 is likely to ensure on its own a function similar to that which would have been ensured by a plurality of separate individual rods.

The draw plates 60 are distributed around the stack 20. In particular, the draw plates 60 are distributed around the axis X20. In the case where an even number of plates 60 is provided, the draw plates 60 are preferably arranged in pairs of plates 60, where, for each pair, the plates 60 are arranged on either side of the stack 20, preferably diametrically opposed relative to the stack 20, in particular relative to the axis X20. Preferably, for each pair of plates 60, the two plates 60 are parallel to each other.

The draw plates 60 are visible in more detail in FIGS. 3 to 5. Each draw plate 60 presents a general flat shape and extends parallel to the direction X10. Here, each draw plate 60 extends according to a respective plate plane P60, which is thus parallel to the direction X10, and is here perpendicular to the direction Y10. The stack 20, the support plate 30, and the springs 50 are arranged between the plates 60.

Each draw plate 60 is separated from any other draw plate 60. In other words, the plates 60 are not attached to each other, other than by means of the base plate 11 and the clamp 40.

Each draw plate 60 comprises anchors, among which primary anchors 61 and secondary anchors 62. The primary anchors 61 attach the draw plate 60 to the base plate 11, according to the direction X10, retaining the draw plate 60 relative to the base plate 11 in the opposite direction to the direction X10. The secondary anchors 62 attach the draw plate 60 to the clamp 40, according to the direction X10, retaining the draw plate 60 according to the direction X10. By means of these arrangements, the draw plates 60 ensure that the stack 20 is maintained in compression between the base plate 11 and the support plate 30, according to the compression direction X10, by means of the primary anchors 61 and the secondary anchors 62, under the action of the springs 50 bearing on the clamp 40. In other words, it is notably by means of the draw plates 60, retaining the clamp 40 relative to the base plate 11, that the force F30 can be applied by the support plate 30 to the stack 20, under the action of the springs 50 bearing on the clamp 40.

Preferably, each draw plate 60 advantageously occupies in width, at least 50%, or even at least 70% of a width L20 of the stack 20, the width L20 of the stack being measured perpendicular to the direction X10 and parallel to the draw plate 60 concerned.

Each draw plate 60 also advantageously comprises a single common tie 63 and several individual ties 64. Each individual tie 64 is attached to the common tie 63, preferably with the possibility of adjusting the position of each individual tie 64 relative to the common tie 63, according to the direction X10. The common tie 63 advantageously carries all the primary anchors 61 of the draw plate 60, while each individual tie 64 advantageously carries only one of the secondary anchors 62 of the draw plate 60, so that any secondary anchor 62 of the plate 60 is carried by one of the individual ties 64 of said plate 60. Alternatively, it could be provided that the primary anchors 61 are carried by the individual ties 64 while the secondary anchors are carried by the common tie 63. Alternatively, another distribution of the anchors 61 and 62 between the ties 63 and 64 can also be envisaged.

According to the direction X10, the common tie 63 advantageously occupies at least 50%, or even at least 70%, and even, preferably, at least 90% of the length of the draw plate 60, while the remaining percentage of the length of the plate 60 is occupied by the individual ties 64. Preferably, the common tie 63 advantageously occupies at least 50%, or even at least 70% of the width L20 of the stack 20, the width L20 being measured perpendicular to the direction X10 and parallel to the plate 60 concerned.

In the present example, carrying the primary anchors 61 at one end of the draw plate 60, the common tie 63 extends from the primary anchors 61, in other words, from the base plate 11, in the opposite direction to the direction X10, in other words, in the direction of the clamp 40. In the present example, carrying the secondary anchors 62 at another end of the plate 60, the individual ties 64 extend from the secondary anchors 62, in other words, from the clamp 40, according to the direction X10, in other words, in the direction of the base plate 11. Each individual tie 64 is attached to the common tie 63, between the base plate 11 and the clamp 40, in other words, between the anchors 61 and 62.

The common tie 63 presents in the form of a solid plate or an openwork lattice, which extends according to the plane P 60 of the draw plate 60. In the present example, the common tie 63 presents in the form of an openwork lattice, which presents the advantage of lightening the common tie 63.

Preferably, the common tie 63 comprises stringers 65, here three stringers 65. Each stringer 65 is a rigid rectilinear member. Each stringer 65 is parallel to the direction X10. The stringers 65 are arranged according to the plane P 60 of the draw plate 60.

Preferably, all the stringers 65 are of the same length. Each stringer 65 extends to one of the individual ties 64, which extends the stringer 65 parallel to the direction X10. Each stringer 65 ends between the clamp 40 and the base plate 11, preferably at the height of the support plate 30. Each individual tie 64 is attached to the common tie 63 by means of one of the stringers 65. According to the direction X10, each stringer 65 advantageously reaches the base plate 11 and preferably passes through the base plate 11. At the height of the base plate 11, each stringer 65 advantageously carries one of the primary anchors 61. Preferably, according to the direction X10, each stringer is axially aligned with the primary anchor 61 which it carries and with the secondary anchor 62 carried by the individual tie 64 attached to this stringer 65. In other words, each stringer 65 is axially aligned, according to the compression direction X10 with two of the anchors 61 and 62 of the draw plate 60, being arranged between said two anchors 61 and 62. Thus, each stringer 65 and the corresponding individual tie 64 are exclusively subjected to tension by the anchors 61 and 62 parallel to the direction X10, if manufacturing and assembly tolerances are neglected. In general, the draw plate 60 is thus exclusively subjected to tension, if manufacturing and assembly tolerances are neglected.

Preferably, for each draw plate 60, if not for at least one of them, at least two stringers 65, namely the stringers placed at the edges of the draw plate 60, are distant by an inter-stringer distance L65 that is greater than 50%, or even greater than 70%, of the width L20 of the stack 20. The inter-stringer distance L65 is measured perpendicular to the direction X10, according to the plane P 60 of the plate 60, and parallel to the width L20 of the stack 20. More generally, parallel to the width L20, the plate 60 is particularly wide, the anchors 61 are particularly distant from each other, and the anchors 62 are particularly distant from each other, so that the plate 60 effectively takes up torsional or bending forces that could be applied to the stack 20.

Preferably, each draw plate 60 comprises one or more crosspieces 66, here three crosspieces 66. Each crosspiece 66 is oriented transversely, preferably perpendicularly, relative to the direction X10, extending preferably in the plane P 60. Each crosspiece 66 is thus transverse, preferably perpendicular, to the stringers 65. Each crosspiece 66 rigidly connects at least two stringers 65 to each other, if not all the stringers 65 of the plate 60 to each other, as in the present example. Overall, the stringers 65 of the plate 60 are rigidly attached to each other by the crosspieces 66, so that the common tie 63 is rigid. For each plate 60, the stringers 65 and the crosspieces 66 form the aforementioned lattice. It can be provided, as in the present example, that openings are delimited by the stringers 65 and the crosspieces 66 of the plate 60, making this plate 60 an openwork plate. Alternatively, it could be provided that these openings are filled, to form a solid plate. The crosspieces 66 rigidly connecting the stringers 65 allow to take up bending and/or shearing forces likely to be applied to the stack 20, so that the whole is particularly stable and resistant. Preferably, at least one crosspiece 66 is arranged between the clamp 40 and the base plate 11, in particular between the anchors 61 and 62, in particular between the ends of the common tie 63, according to the direction X10. Here, this is the case for all the crosspieces 66 of the plate 60.

Preferably, as visible in FIGS. 3 and 5, each stringer 65 is received in a respective notch 16, belonging to the base plate 11, passing through said notch 16. Each notch 16 is advantageously formed on an edge, at the perimeter of the base plate 11. Each notch 16 passes through the base plate 11 from side to side according to the direction X10 and is passed through from side to side by the stringer 65. On one side of the base plate 11 that is opposite the stack, the anchor 61 bears against the base plate 11 in the opposite direction to the compression direction X10, preferably at the outlet of the notch 16. Preferably, the base plate 11 comprises one or more recesses 17, formed on this side of the base plate 11, to receive the anchors 61 in a recessed manner in the base plate 11, to thus limit, or even block, the movement of the anchor 61 relative to the plate according to the two transverse directions Y10 and Z10, preferably in both directions of each transverse direction Y10 and Z10. If applicable, the notches 16 open into said recesses 17, to allow the anchors 61 to engage in the notches 16 according to a transverse direction perpendicular to the plane P60.

Preferably, at least one of the anchors 61, and even each anchor 61, comprises at least one wing 67, or even two wings 67. Here, each anchor 61 comprises two wings 67. Each wing 67 extends transversely relative to the direction X10, in particular according to the plane P60, protruding radially from the stringer 65. Here, for each stringer 65, the two wings 67 are formed on either side of the stringer 65. It can be provided that, for two neighboring anchors 61, the adjacent wings 67, belonging one to one of the two anchors 61 and the other to the other of the two anchors 61, are connected, as is the case on the left in FIG. 5, or disjointed, as is the case on the right in FIG. 5. It is by means of said wings 67 that the anchor 61 bears against the base plate 11 in the opposite direction to the direction X10. It is advantageously provided that each wing 67 is received in the recess 17. It is by means of the wings 67 that the draw plate 60 is attached to the base plate 11, being retained by the wings, in the opposite direction to the direction X10. The wings 67 being arranged in the plane P 60 of the plate, the attachment of the draw plate 60 to the base plate 11 does not induce or induces little bending stresses on the draw plate 60, except possibly locally at the level of the wings 67. Preferably, the draw plate 60 is not fixed to the base plate 11 but only retained in the opposite direction to the direction X10 by the anchors 61, and positioned transversely relative to the base plate 11, transversely relative to the direction X10, here by receiving the stringers 65 in the notches 16. This allows to limit stress concentrations at the level of the anchors 61 and to facilitate the assembly of the draw plates 60, as there is no need to fix the plates 60 to the base plate 11.

Preferably, as visible in FIG. 5, each notch 16 is open according to a transverse direction relative to the direction X10, here according to the direction X10, over its entire length. Thus, laterally open, each notch 16 allows to introduce into each stringer 65 into its respective notch 16 by a movement in translation of the draw plate 60 parallel to the direction Y10, relative to te base plate 11, by approaching the draw plate 60, in its final orientation, until each stringer 65 is received in its respective notch 16, with the positioning of the anchors 61 against the base plate 11. If the recess 17 is provided, it can also be provided that the recess 17 is laterally open, here according to the direction Y10, as with the notches 16, so that the anchors 61 may be received by an introduction parallel to the direction Y10. By means of these arrangements, the draw plate 60, in one piece, can be introduced into all the notches 16 at once, so that the assembly of the plate 60 on the clamp 40 is facilitated and can be carried out in a single move, preferably without tools.

Preferably, each draw plate 60 includes as many primary anchors 61 as secondary anchors 62, here three of each. Preferably, each plate 60 includes as many stringers 65 as individual ties 64, here three of each. Preferably, each plate 60 includes as many stringers 65 as primary anchors 61, here three of each. Preferably, each plate 60 includes as many individual ties 64 as secondary anchors 62, here three of each.

For each draw plate 60, the individual ties 64 are preferably arranged according to the plane P 60, being distributed over the width of the plate 60. Preferably, each individual tie 64 presents the form of a rod, or an elongated element, parallel to the direction X10. This rod extends one of the stringers 65, if such a stringer 65 is provided for the common tie 63, parallel to the direction X10. Each individual tie 64 is attached to the common tie 63, in particular, is attached respectively to one of the stringers 65 of the common tie 63. This attachment is made at one of the ends of the individual tie 64, and at a corresponding end of the stringer 65. Preferably, according to the direction X10, each tie 64 is axially aligned with the primary anchor 62 it carries and with the primary anchor 61 carried by the stringer 65 attached to this individual tie 64. In other words, each tie 64 is axially aligned, according to the compression direction X10 with two of the anchors 61 and 62 of the draw plate 60, being arranged between said two anchors 61 and 62.

Each tie 64 is preferably rigid, as with the stringers 65, if they are provided, or as with the common tie 63. Unlike the stringers 65 which are connected to each other by the crosspieces 66, the ties 64 are not connected to each other, other than by the clamp 40 and by the common tie 63 of the draw plate 60. Preferably, all the ties 64 are of the same length. Preferably, for each draw plate 60, if not for at least one of them, at least two ties 64, namely the ties placed at the edges of the draw plate 60, are distant by an inter-tie distance L64 that is greater than 50%, or even greater than 70%, of the width L20 of the stack 20. The distances L64 and L65 are advantageously equal or close. The inter-tie distance L64 is measured perpendicular to the direction X10, according to the plane P60 of the draw plate 60, and parallel to the width L20 of the stack 20.

In the opposite direction to the direction X10, each tie 64 reaches the clamp 40, and, preferably, the crosspiece. Preferably, as visible in FIGS. 3 and 4, each individual tie 64 is received in a respective notch 18, each notch 18 being formed in the clamp 40, and each individual tie 64 passing through said respective notch 18. Each notch 18 is advantageously formed at the end of one of the arms 42, 43, 44, 45, 46, and 47 of the clamp. Each notch 18 passes through the clamp 40 from side to side according to the direction X10 and is passed through from side to side by the tie 64. On one side of the clamp 40 that is opposite the stack 20, the anchor 62 bears against the clamp 40 according to the compression direction X10, in particular, against one of the arms 42 to 47, preferably at the opening of the notch 18. Preferably, the clamp 40 comprises, for each anchor, a counterbore or a recess, formed on this side of the clamp 40, to receive the anchor 62 in a recessed manner in the clamp 40. If applicable, the notches 18 open into said counterbore or recess.

Preferably, at least one of the anchors 62, and even each anchor 62, forms a head, such as a screw head, which is fixedly attached to the end of the tie 64 that carries this anchor 62. Preferably, the head is made of material with the tie 64. In this case, it can be provided that a screw forms both the tie 64 and the anchor 62 carried by this tie 64.

It is advantageously provided that the anchor 62 extends in the plane P 60, in other words, without being offset from the plane P60 according to a direction perpendicular to this plane P 60. It is by means of the head that the anchor 62 comes to bear against the clamp 40 according to the direction X10. It is by means of the head of the anchors 62 that the draw plate 60 is attached to the clamp 40, being retained by the heads, according to the direction X10. The anchors 62 being arranged in the plane P 60 of the plate, the attachment of the plate 60 to the clamp 40 does not induce or induces little bending stresses on the plate 60, except possibly locally at the level of the anchors 62. Preferably, the plate 60 is not fixed to the clamp 40, but only retained according to the direction X10 by the anchors 62, and positioned transversely relative to the clamp 40, transversely relative to the direction X10, here by receiving the ties 64 in the notches 18. This allows to limit stress concentrations at the level of the anchors 62 and facilitates the assembly of the plates 60, as there is no need to fix the plates 60 to the clamp 40.

Preferably, each individual tie 64 is individually adjustable in position relative to the common tie 63 according to the direction X10, in that each individual tie 64 is linked to the common tie 63 by a respective helical connection 68, centered on an axis that is coaxial with the individual tie 64 and with the corresponding stringer 65. In practice, this helical connection 68 can comprise an external thread, formed at the end of the individual tie 64, and an internal thread, formed inside a hole carried at the end of the stringer 65 concerned. The external thread of the tie 64 is received inside the hole of the stringer 65 and screwed into the internal thread. Thus, when the tie 64 is pivoted around its own axis relative to the tie 63, a displacement of the tie 64 relative to the tie 63 is obtained, according to the direction X10, independently of the other ties 64. The anchor 62 being carried by the tie 64, the adjustment of the position of the tie according to the direction X10 allows the position of the anchor 62 to be adjusted according to the direction X10, relative to the common tie 63. Each anchor 62 can therefore individually be adjusted in position to adjust the force F30 applied by the support plate 30, by adjusting the position of the clamp 40 using the ties 64.

Preferably, as visible in FIG. 3, each notch 18 is open according to a transverse direction relative to the direction X10, here according to the direction Y10, over its entire length. Thus, laterally open, the notches 18 allow the introduction of each tie 64 into its respective notch 18 by movement in translation of the draw plate 60 parallel to the direction Y10, relative to the clamp 40, by approaching the plate 60, in its final orientation, until each tie 64 is received in its respective notch 18, with positioning of the anchors 62 against the clamp 40. If a counterbore or recess is provided on the clamp to accommodate the anchor 62, it is also provided that the counterbore or recess is laterally open, here according to the direction Y10, as with the notches 18, so that the anchors 62 can be received therein by introduction parallel to the direction Y10. By means of these arrangements, the plate 60 can be introduced in one piece into all the notches 18 at once, so that the assembly of the plate 60 on the clamp 40 is facilitated and can be carried out in a single move, preferably without tools.

By means of the open notches 16 and 18, the assembly is even simpler in that the draw plate 60 can be mounted, in one go, both onto the clamp 40 and onto the base plate 11, by lateral movement in translation of the draw plate 60 in the direction of the clamp 40 and the base plate 11, while they already surround the stack 20, via the springs 50 and the support plate 30. Once the plates 60 are mounted, the tightening of the stack is carried out by adjusting the position of the individual ties 64 according to the direction X10, here by screwing, to gradually tighten the stack 20 until the desired force F30 is obtained.

In the illustrated example, the clamp 40 is a single clamp. Moreover, it is made in one piece, monobloc, for example, a cast metal piece. However, the clamp 40 could be made in several parts independent of each other. For example, it could be provided that each pair of secondary arms (42, 45), (42, 46), and (44, 47), formed of two secondary arms that extend in the opposite direction according to the direction Y10, forms a part of the clamp independent of the other parts. In the case of a clamp including four pairs of two secondary arms that extend in the opposite direction according to the direction Y10, a clamp in two parts independent of each other can be provided, each independent part including its own main arm, parallel to the direction Z1, and two pairs of secondary arms respectively formed of two secondary arms that extend in the opposite direction according to the direction Y10 from the main arm of the part concerned. Preferably, each part of the clamp is symmetrical relative to a median plane perpendicular to the direction Y10. Even in the presence of a clamp in several independent parts, the whole of the clamp thus constituted is solicited by the two plates of the draw plates 60 comprising the anchors 61, 62 by means of which each draw plate 60 is attached to the base plate 11 and to each of the different parts of the clamp 40, the draw plates 60 thus ensuring that the stack 20 is maintained in compression between the base plate 11 and the support plate 30, according to the compression direction X10, by means of the anchors 61, 62, under the action of the springs 50 bearing on the different parts of the clamp 40. Preferably, for each independent part of the clamp, a second sliding connection can be provided, notably as described above, by means of which said independent part of the clamp 40 is guided in sliding relative to the support plate 30, according to the compression direction X10.

Any feature described above for one embodiment or alternative can be implemented for the other embodiments or alternatives described above, insofar as far as technically possible.

1.-15. (canceled)

16. A fuel cell, comprising:
a base plate;
a stack, which comprises electrochemical cells stacked according to a compression direction, and which is held against the base plate according to the compression direction; and
a compression system, which comprises:
a support plate, which is movable relative to the base plate parallel to the compression direction, and which is held against the stack according to the compression direction;
springs, which are held against the support plate according to the compression direction; and
a clamp, which is held against the springs according to the compression direction;
wherein:
the fuel cell comprises a first sliding connection, by means of which the support plate is guided in sliding relative to the base plate, according to the compression direction; and
the compression system further comprises draw plates, separated from each other, each draw plate comprising anchors by means of which the draw plate is attached to the base plate and to the clamp, the draw plates thus ensuring that the stack is maintained in compression between the base plate and the support plate, according to the compression direction, by means of the anchors, under the action of the springs bearing on the clamp.

17. The fuel cell according to claim 16, wherein the first sliding connection comprises a primary slide, attached to the support plate, and a secondary slide, attached to the base plate, the primary slide and the secondary slide being received within each other, so as to slide relative to each other according to the compression direction, thus guiding the sliding of the support plate relative to the base plate.

18. The fuel cell according to claim 17, wherein:
the fuel cell comprises a casing, which contains the stack and the compression system and the clamp and which is fixedly attached to the base plate; and
the secondary slide is fixedly attached to the base plate by being fixedly attached to the casing.

19. The fuel cell according to claim 18, wherein the secondary slide is fixedly attached to the base plate by being fixedly attached to the casing at the height of the clamp or the springs according to the compression direction.

20. The fuel cell according to claim 16, wherein each draw plate comprises a common tie and individual ties, which carry the anchors, each individual tie being attached to the common tie and having a position adjustable relative to the common tie according to the compression direction, to adjust the position of the anchors by means of which the draw plate is attached to the clamp relative to those of the anchors by means of which the draw plate is attached to the base plate.

21. The fuel cell according to claim 20, wherein, for the respective position of the individual ties relative to the common tie to be adjustable, each individual tie is linked to the common tie by a helical connection parallel to the compression direction.

22. The fuel cell according to claim 16, wherein each draw plate comprises stringers, parallel to the compression direction.

23. The fuel cell according to claim 22, wherein each draw plate comprises a crosspiece, rigidly connecting the stringers to each other by being fixedly linked to said stringers, the crosspiece being arranged between the clamp and the base plate.

24. The fuel cell according to claim 22, wherein, for each draw plate, at least two stringers are distant by an inter-stringer distance that is greater than 50% of a width of the stack, the inter-stringer distance being measured perpendicular to the compression direction and the width of the stack being measured parallel to the inter-stringer distance.

25. The fuel cell according to claim 22, wherein each stringer is axially aligned, according to the compression direction, with one of the anchors of the draw plate, or with two of the anchors of the draw plate, being arranged between said two anchors.

26. The fuel cell according to claim 22, wherein at least one of the anchors comprises at least one wing, which extends radially from said stringer and which bears against the base plate in the opposite direction to the compression direction, to attach the draw plate to the base plate, said at least one wing being arranged in a plane along which the stringers extend.

28. The fuel cell according to claim 16, wherein, for each draw plate, the anchors comprise primary anchors, by means of which the draw plate is attached to the base plate, and secondary anchors, by means of which the draw plate is attached to the clamp.

29. The fuel cell according to claim 16, wherein the draw plates comprise a first draw plate and a second draw plate, which are parallel to each other.

30. The fuel cell according to claim 29, wherein the first draw plate and the second draw plate are arranged on either side of the stack, the opposite way relative to the stack.

31. The fuel cell according to claim 16, wherein the fuel cell comprises a second sliding connection, by means of which the clamp is guided in sliding relative to the support plate, according to the compression direction.

32. The fuel cell according to claim 16, wherein the clamp is made in different parts independent of each other.
